(19) United States
(12) Patent Application Publication
(10) Pub. No.: US 2003/0112567 A1
(43) Pub. Date: Jun. 19, 2003

(54) DEVICE PREVENTING FROM CHIP DAMAGE CAUSED BY OVER VOLTAGE

(76) Inventor: Henry Sun, Taipei (TW)

Correspondence Address: Cecilia L. Yu, Esq., LAW OFFICES OF CECILIA L. YU & ASSOCIATES, Suite 415, 17800 Castleton Street, Industry, CA, 91748, US

(21) Appl. No.: 10/022,778

(22) Filed: Dec. 13, 2001

(51) Int. Cl. H02H 3/20

(52) U.S. Cl. 361/90

(57) ABSTRACT

A device in a computer system which can prevent the chip coupled to a 4× video card expansion slot from damage and the damage is caused by plugging a 2× video card into the 4× video card expansion slot. When the type of the plugged video card is 2×, the device can lower the voltage of the electric current that inputted to the VCC3 contacts of the 4× expansion slot to below 1.65 volt and keep the chip safe. If the type of the plugged video card is 4×, the device will not change the voltage of the electric current which flows to the VCC3 contacts of the 4× expansion slot, the 4× video card can therefore normally run.

### BACKGROUND OF THE INVENTION

1. Field of the Invention

The present invention relates to a device in a computer system which can prevent from chip damage caused by over voltage, and more particularly the over voltage is caused by plugging a 2× video card into a 4× video card expansion slot.

2. Description of the Related Art

Video card provided with personal computer function as a hardware interface with a display device. Video card transfer the signal data sent from CPU to the form which monitor can display. Processing speed of video card will influence display quality. There are two kind of video card in the present market the 2× video card and 4× video card. Each type of video card is adapted to corresponding video card expansion slot called 2× video card expansion slot and 4× video card expansion slot. The 2× video card has two strobe wires and the 4× video card has four strobe wires. The strobe wires cooperate with the clock generator. The processing speed of 2× video card is 512 MB/sec while the processing speed of the 4× video card is two times that of the 2× video card. That is about 1 GB/sec. There are four kinds of contacts (golden fingers) of the video card and expansion slot which are the 12 voltage contact, 5 voltage contact, 3.3 voltage contact and 1.5 voltage contact. Beside the 1.5 voltage power, the other three kind of voltage powers are already existed in the mother board power supply system. If cataloged by the function of the contacts, they can be cataloged to VCC3 contacts, VDDQ contacts and other kinds of contacts. Before the electric current flows to the VDDQ contacts, there is a branch current flows to the chip.

In the 2× video card and expansion slot, the contact voltage of the VCC3 contacts and VDDQ contacts are all 3.3 (±0.15) voltage and the electric current which pass through the VCC3 contacts will met the electric current which pass through the VDDQ contacts on the 2× video card since the voltage value of the VCC3 contacts and the VDDQ contacts are the same and the arrangement can provide strong electric current.

FIG. 1 illustrates a 4× video card 2 plugged into a 4× video card expansion slot 1 which comprising VCC3 contacts and VDDQ contacts. The voltage of the VCC3 contacts supplied directly from the power Supplier 5 is 3.3 volt. The voltage of the VDDQ contacts is 1.5 volt which is supplied from the 3.3 volt power source of the power supplier 5 then regulated to 1.5 volt via a regulator 3. The electric current regulated by the regulator 3 not only flows to the VDDQ contacts but also flows to the Intel82845 chip 4. The Intel82845 chip 4 is designed to cooperate with the 4× video card which can stand at most 1.65 volt. Since the current which pass through the VCC3 contacts doesn't mix with the current which pass through the VDDQ contacts, the voltage of the current which flows to the chip 4 is always 1.5 volt and the chip 4 will not be damaged caused by over voltage but if a 2× video card plugged into a 4× video card expansion slot, the case will be different.

FIG. 2 illustrates a 2× video card 2 plugged into a 4× video card expansion slot 10 which comprising VCC3 contacts and VDDQ contacts. The voltage of the VCC3 contacts supplied directly from the power supplier 14 is 3.3 volt. The voltage of the VDDQ contacts is 1.5 volt which is supplied from the 3.3 volt power source of the power supplier 14 then regulated to 1.5 volt via a regulators 3. The electric current regulated by the regulator 13 not only flows to the VDDQ contacts but also flows to the Intel82845 chip 12. The electric current which pass through the VCC3 contacts will met the electric current which pass through the VDDQ contacts on the 2× video card 11, then the 3.3 volt current will flow from the VCC3 contacts through the 2× video card and the VDDQ contacts to the Intel82845 chip 12. As mentioned above, Intel82845 chip is designed to cooperate with a 4× video card which can stand at most 1.65 volt, therefore, the Intel82845 chip 12 will be damaged by over voltage.

Although the video card expansion slot manufacturers have provided some mechanical device to prevent from plugging the wrong video card, however, there are many video card manufacturers who are not expansion slot makers, some of the video cards they made still can be plugged into the video card expansion slots with incorrect specification and lead to the north bridge chip damage.

North bridge chip (sometimes it is integrated with South bridge chip) is an essential component on the mother board and If it is burned or damaged, the whole computer system won't work any more.

### SUMMARY OF THE INVENTION

It is therefore an object of the invention to provide a device in a computer system which can prevent the chip coupled to the video card expansion slot from damage cause by plugging a 2× video card into a 4× video card expansion slot.

The present invention is adapted to a 4× video card expansion slot comprising a detecting contact which can judge the type of the video card plugged into the video card expansion slot is 2× or 4× and multiple 3.3 volt VCC3 contacts and 1.5 volt VDDQ contacts. The wire on the 2× video card which contact the detecting contact is floating while the wire on the 4× video card which contact the detecting contact is grounded. The detecting contact can judge the type of the video card by detecting the voltage. If the result of the voltage detecting is floating, it's a 2× video card and if the result of the voltage detecting is zero, the type of the video card is 4×.

The present invention comprises:

(1) an inverter, comprising a first power input terminal and coupled to said detecting contact, if the detection result indicate a 2× video card, the output voltage of said inverter is zero and if the detection result indicate a 4× video card, the output voltage of said inverter is floating. The inverter can also be a Transistor Transistor Logic integrated circuit (TTL IC).For example the TTL IC with the specification of TTL7404, TTL7405 or TTL7406.

(2) a voltage controller, comprising a 3.3 volt second power input terminal and coupled to said inverter, if the output voltage of said inverter is zero, the output voltage of said voltage controller is below 1.65 voltage, if the output voltage of said inverter is floating, the output voltage of said voltage controller is the same as said second power input terminal.

(3) a power input controller, comprising a 3.3 volt third power input terminal, coupled to said voltage controller, and controlling the power inputted into said 3.3 volt VCC3 contacts is the same as said output voltage of said voltage controller.

The power source of the first, second and third power input terminals are from the power supplier of the computer system.

Therefore, If the plugged video card is the correct 4× video card, the present invention device won't change the voltage of the power (3.3 volt) inputted into the 3.3 volt VCC3 contacts and if the plugged video card is 2× video card, the power comes from the power supply will be lowered by the present invention device to less than 1.65 volt then transmitted to the 3.3 volt VCC3 contacts. In that case, even the electric current flow from the VCC3 contacts through the 2× video card and the VDDQ contacts to the Intel82845 chip, it won't burn the intel82845 chip because it is lower than 1.65 volt.

Since the VCC3 contacts and VDDQ contacts of the 2× video card need 3.3 volt electric currents, the electric current with voltage lower than 1.65 volt to the VCC3 contacts and the regulated 1.5 volt electric current to the VDDQ contacts won't start the 2× video card because it is incorrectly plugged in.

### BRIEF DESCRIPTION OF THE DRAWINGS

FIG. 1 is a diagram depicting a conventional power system of a 4× video card plugged into a 4× video card expansion slot.

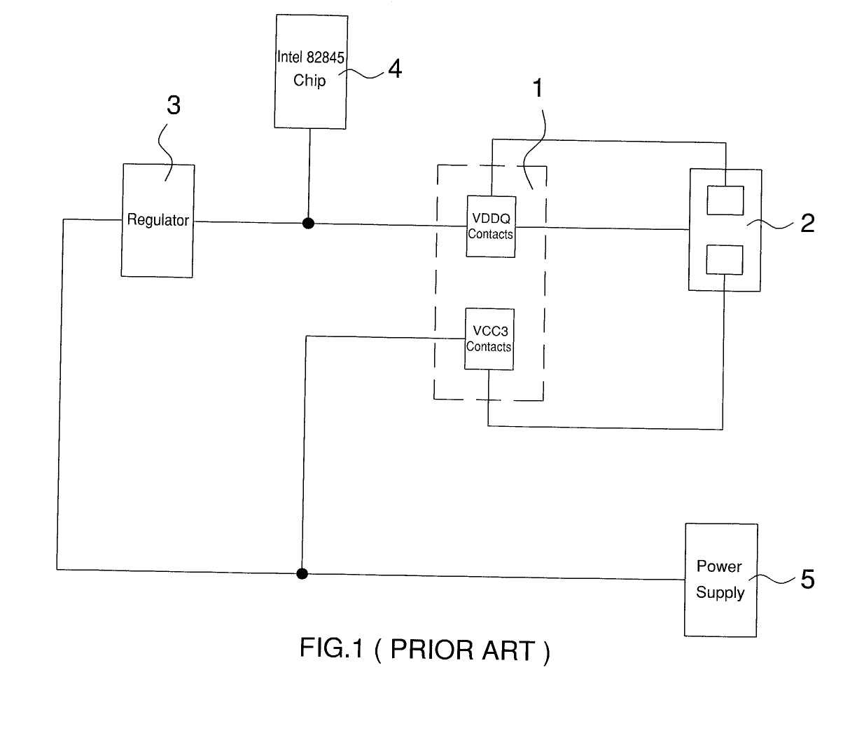

FIG. 2 is a diagram depicting a conventional power system of a 2× video card plugged into a 4× video card expansion slot.

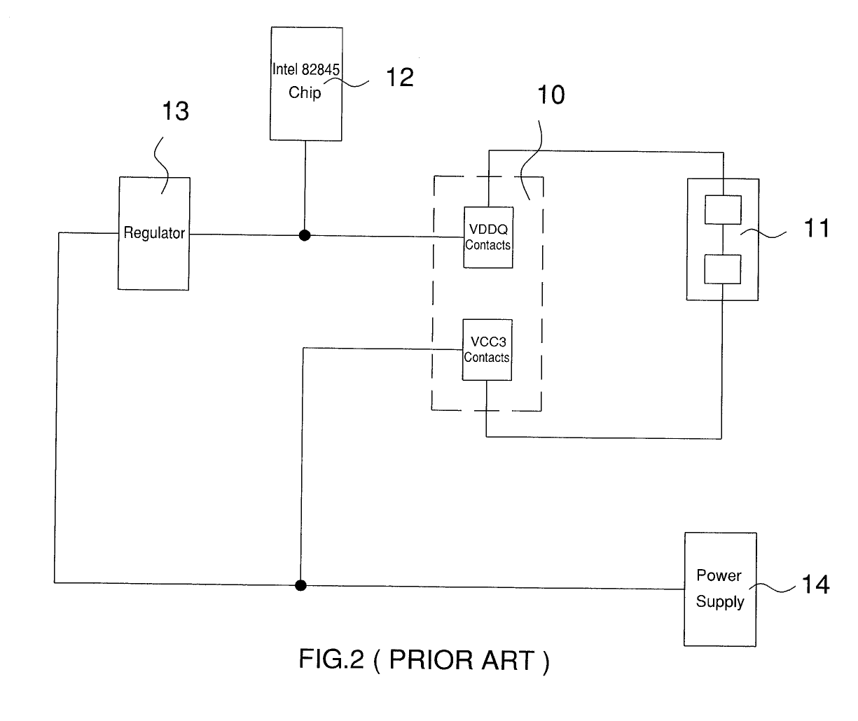

FIG. 3 is a diagram depicting a power system of a 2× video card plugged into a 4× video card expansion slot with the present invention.

FIG. 4 is a detailed circuit diagram of a preferred embodiment of the present invention.

### DETAILED DESCRIPTION OF THE PREFERRED EMBODIMENT

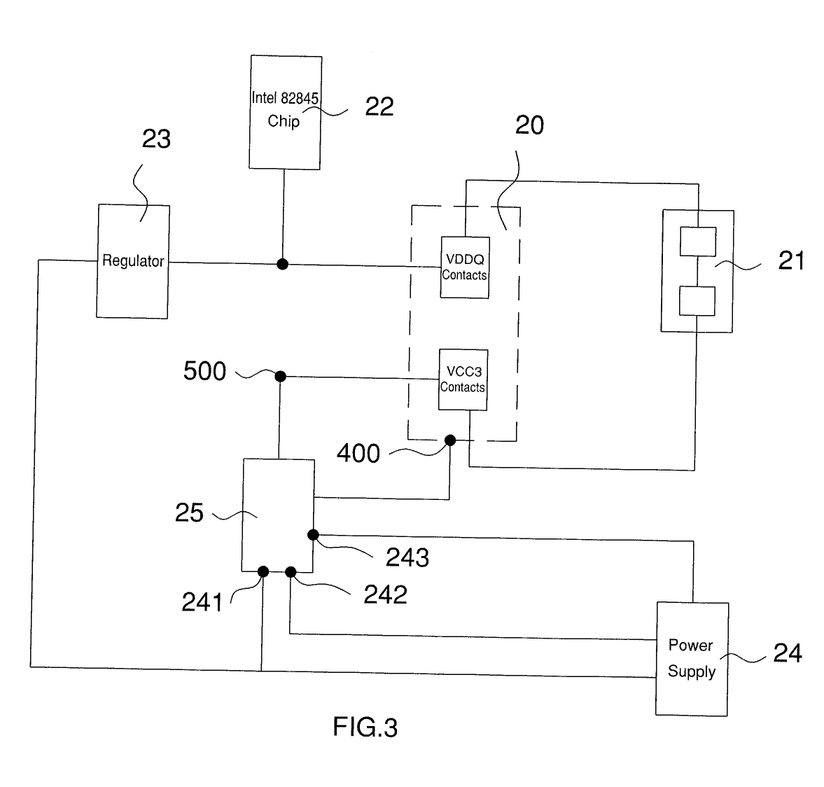

Referring now to the diagram FIG. 3 which sets forth a preferred embodiment of the present invention adapted to system that 2× video card 21 plugged into a 4× video card expansion slot 20. When the detecting result of the detecting contact 400 indicate the type of the video card plugged in to the 4× video card expansion slot 20 is 2×, the present invention device 25 provides the first power input terminal 241 and the second power input terminal 242 as a control power source in order that the voltage of the electric current flowing from the third power input terminal 243 to the 3.3 volt VCC3 contacts of the slot 20 be reduced to 1.5 volt so the intel82845 north bridge chip 22 coupled to the VDDQ contacts will not be damaged.

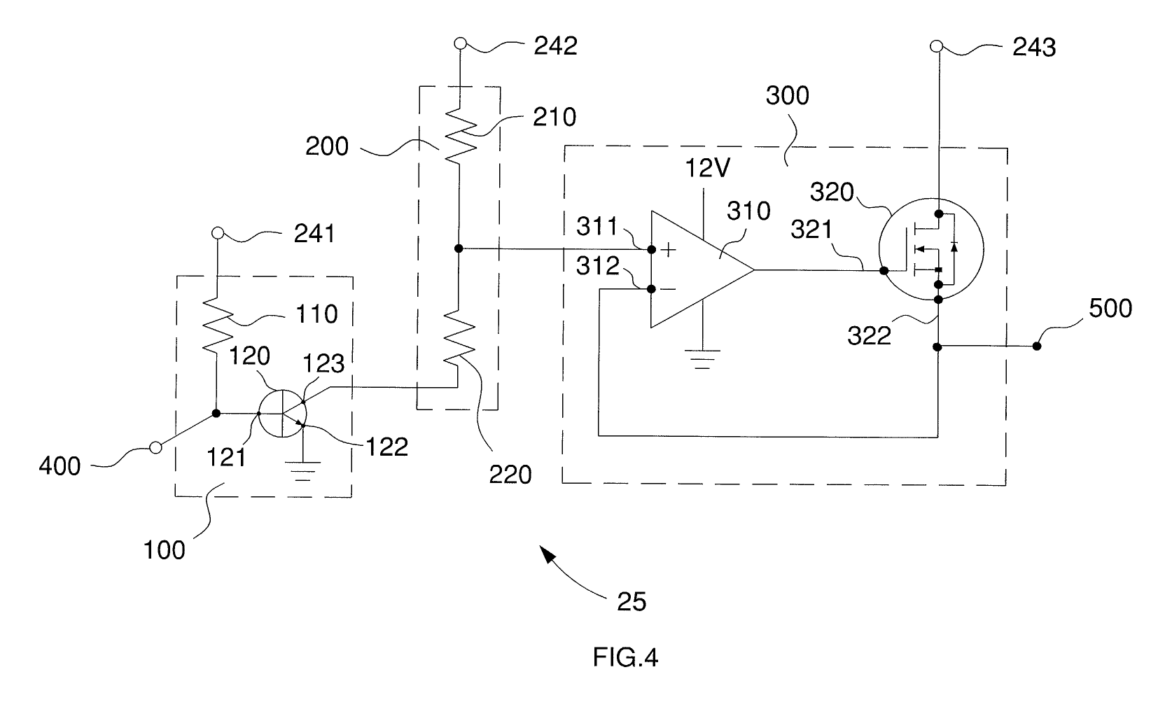

A detailed circuit diagram of a preferred embodiment of the present invention is illustrated in FIG. 4. The preferred embodiment comprises three parts: the inverter 100, the voltage controller 200 and the power input controller 300.

The detecting contact 400 of the 4× video card expansion slot is coupled to the inverter 100. The inverter 100 comprises the 10K ohm resistor 110, the silicon transistor 120 and the 3.3 volt first power input terminal 241 in series connection. The wire on the 2× video card which contact the detecting contact cooperates with the resistor 110 and the 3.3 volt first power input terminal 241 makes the voltage of the base pole 121 of the transistor 110 is a little higher than 0.7 volt and the transistor 110 will enter saturation region, so the voltage of the collector pole 123 will be zero.

The voltage controller 200 comprises the 3.3 volt second power input terminal 242, the 1.2K ohm resistor 210 and the 1.0K ohm resistor 220 in series connection. Since the output voltage of the inverter 100 is zero, the output voltage of the voltage controller 200 can be calculated according to the partial voltage theorem of the Electronics:

V=(3.3−0)×(1÷(1+1.2))=1.5 volt

and the current is

I=(3.3−0)÷(1000+1200)=0.0015 ampere

The power input controller 300 comprises the operational amplifier 310 and the HUF76107 MOSFET 320. After the computer is started, as we know from above, the voltage of the positive pole 311 is 1.5 volt and the voltage of the negative pole 312 is zero. Since the voltage of the positive pole 311 is much higher than that of the negative pole 312, the output voltage of the operational amplifier 310 will be much higher than 1.5 volt, for example 3 volt. Therefore the voltage of the gate pole 321 of the MOSFET 320 is much higher than that of the source pole 322 which is zero in the beginning, so the status of the MOSFET 320 is turn-on and the electric current from the third 3.3 volt power input 243 will pass through the MOSFET 320 to the negative pole 312 then the voltage of the negative pole 312 will increase to equal or a little higher than the voltage of the positive pole 311 and the output voltage of the amplifier 310 will be decreased so the voltage of the gate pole 321 of the MOSFET 320 is only a little higher than that of the source pole 322 and the status of the MOSFET 320 is tun-off, then the voltage of the negative pole 312 will be lower than the voltage of the positive pole 311.

Through the cycling of the process described, the 3.3 volt VCC3 contacts 500 coupled to the MOSFET 320 and the negative pole 312 can therefore be controlled within a very small difference of 1.5 volt which is lower than 1.65 volt and the intel82845 north bridge chip 22 can be safe.

When the video card plugged into the 4× video card expansion slot 20 is a 4× video card and since the wire on the 2× video card which contact the detecting contact is grounded, the voltage of the base pole 121 of the transistor 110 is zero so the voltage of the collector pole 123 will be floating and the output of the voltage controller 200 will therefore be the same as the 3.3 volt second power input terminal 241. The power input controller 300 according to the cycling process described above can therefore control the 3.3 volt VCC3 contacts 500 which is coupled to the MOSFET 320 and the negative pole 312 to be close to 3.3 volt. Since electric current from the third 3.3 volt power input terminal to the 3.3 volt VCC3 contact doesn't pass through resistors, it can provide enough current (about 1 to 6 ampere) to run the 4× video card.

Although the preferred embodiment of the present invention is detailed described, the device still can be carried out with different elements and arrangements. This preferred embodiment is presented only by way of example and is not limited the scope of the present invention which is defined by the following claims.

What is claimed is:

1. A device preventing a chip from damage caused by plugging a 2× video card into a 4× video card expansion slot, said 4× video card expansion slot has a detecting contact for detecting the type of a plugged video card and multiple 3.3 volt and 1.5 volt contacts, and said chip is coupled to said 1.5 volt contacts, said device comprises:
an inverter, comprising a first power input terminal and coupled to said detecting contact, if the detection result indicate a 2× video card, the output voltage of said inverter is zero and if the detection result indicate a 4× video card, the output voltage of said inverter is floating;
a voltage controller, comprising a 3.3 volt second power input terminal and coupled to said inverter, if the output voltage of said inverter is zero, the output voltage of said voltage controller is below 1.65 voltage, if the output voltage of said inverter is floating, the output voltage of said voltage controller is the same as said second power input terminal;
a power input controller, comprising a 3.3 volt third power input terminal, coupled to said voltage controller, and controlling the power inputted into said 3.3 volt contacts is the same as said output voltage of said voltage controller.

2. The device as set forth in claim 1, wherein said inverter comprises a resistor and a silicon transistor.

3. The device as set forth in claim 2, wherein said resistor and said transistor are in series connection.

4. The device set forth in claim 1, wherein said inverter is a TTL IC.

5. The device set forth in claim 1, wherein said power input controller comprises:
an operational amplifier, which positive pole is connected to the output terminal of said voltage controller;
a MOSFET, which gate pole is connected to the output terminal of said operational amplifier and which source pole is connected to said the negative pole of said operational amplifier and said 3.3 volt contacts of said video card expansion slot.

6. The device set forth in claim 1, wherein said chip is a north bridge chip.

7. The device set forth in claim 1, wherein said first power terminal is a 5 volt power terminal.

8. The device set forth in claim 1, wherein said first power terminal is a 3.3 volt power terminal.
